(19) United States
(12) Patent Application Publication
(10) Pub. No.: US 2024/0377247 A1
(43) Pub. Date: Nov. 14, 2024

(54) OPTOELECTRONIC DEVICE

(71) Applicant: LITE-ON TECHNOLOGY CORPORATION, TAIPEI CITY (TW)

(72) Inventors: BO-JHIH CHEN, New Taipei City (TW); CHUNG-CHAN WU, TAIPEI CITY (TW); MENG-SUNG CHOU, NEW TAIPEI CITY (TW)

(21) Appl. No.: 18/780,495

(22) Filed: Jul. 23, 2024

Related U.S. Application Data
(63) Continuation-in-part of application No. 18/187,545, filed on Mar. 21, 2023, now Pat. No. 12,072,236.
Application No. 18/187,545 is a division of application No. 17/095,078, filed on Nov. 11, 2020, now Pat. No. 11,644,360.
(60) Provisional application No. 63/640,902, filed on May 1, 2024.
(60) Provisional application No. 62/935,671, filed on Nov. 15, 2019.

(30) Foreign Application Priority Data
Sep. 23, 2020 (CN) 202011012537.1

(51) Int. Cl. G01J 1/08; F21K 9/90; F21V 5/00; F21V 17/10; F21Y 105/16; F21Y 113/10; G01J 1/04; G01J 1/42; G03B 21/14; G03B 21/20; G03B 21/26; H05B 35/00

(52) U.S. Cl. CPC G01J 1/08; F21V 5/007; F21V 17/101; G01J 1/0474; G01J 1/42; G03B 21/145; G03B 21/26; H05B 35/00; F21K 9/90; F21Y 2105/16; F21Y 2113/10; G03B 21/2033

(57) ABSTRACT

An optoelectronic device includes a substrate, a light emitting/receiving unit, a mask, a light shielding layer, and a first light-transmissive component. The light emitting/receiving unit is disposed on the substrate and includes an emitting/receiving side and a metal pattern disposed on the emitting/receiving side. The emitting/receiving side has an active area, and the metal pattern surrounds the active area. The mask covers the metal pattern. The light shielding layer is disposed on the substrate and surrounds the light emitting/receiving unit. The first light-transmissive component covers the light emitting/receiving unit, the mask, and the light shielding layer.

### CROSS-REFERENCE TO RELATED PATENT APPLICATION

This application is a continuation-in-part application of the U.S. patent application Ser. No. 18/187,545, filed on Mar. 21, 2023, and entitled “LIGHT SENSING MODULE AND ELECTRONIC DEVICE USING THE SAME,” now pending, which is a divisional application of the U.S. application Ser. No. 17/095,078, filed on Nov. 11, 2020 and entitled “LIGHT SENSING MODULE AND ELECTRONIC DEVICE USING THE SAME”, now issued as U.S. Pat. No. 11,644,360 B2, the entire disclosures of which are incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optoelectronic device, and more particularly to a high-performance optoelectronic device, which can be used in a wearable smart product for monitoring physiological signals.

### BACKGROUND OF THE DISCLOSURE

In recent years, people have paid more attention to health management, and the need for close monitoring of health conditions has increased during the covid-19 pandemic period. This leads to development and popularization of smart wearable products, which can record important physiological parameters (e.g., human body temperatures, blood oxygen concentrations, heart rates, and an electrocardiogram) of a person to be detected in a non-invasive manner at any time, and can help alert or prevent possible changes in health status.

The smart wearable products are usually equipped with a light emitter and a light sensor that are used for monitoring physiological signals. However, the crosstalk of stray light can affect the accuracy of the physiological signals detected by the smart wearable products. In addition, if inside the light sensor metal surfaces are exposed, the metal surfaces are visible to the naked eye, and the reflection of the metal surfaces would produce stray light. Therefore, the light sensor fails to meet the appearance requirements of the smart wearable products and is considered as lacking accuracy.

### SUMMARY OF THE DISCLOSURE

In response to the above-referenced technical inadequacies, the present disclosure provides an optoelectronic device, which can meet the appearance requirements of smart wearable products, such as avoiding the exposing of metal surfaces.

In order to solve the above-mentioned problems, one of the technical aspects adopted by the present disclosure is to provide an optoelectronic device, which includes a substrate, a light emitting/receiving unit, a mask, a light shielding layer, and a first light-transmissive component. The light emitting/receiving unit is disposed on the substrate and includes an emitting/receiving side and a metal pattern disposed on the emitting/receiving side. The emitting/receiving side has an active area, and the metal pattern surrounds the active area. The mask covers the metal pattern. The light shielding layer is disposed on the substrate and surrounds the light emitting/receiving unit. The first light-transmissive component covers the light emitting/receiving unit, the mask, and the light shielding layer.

In one of the possible or preferred embodiments, a thickness of the light shielding layer is gradually decreased along a direction away from the light emitting/receiving unit.

In one of the possible or preferred embodiments, the optoelectronic device further includes a blocking wall that is disposed on the substrate and surrounds the light emitting/receiving unit, the mask, the light shielding layer, and the first light-transmissive component.

In addition, the first light-transmissive component has an upper surface and a lateral surface perpendicular to the upper surface. The blocking wall includes a shielding portion extending in a direction parallel to an extension direction of the lateral surface and a masking portion extending in a direction parallel to an extension direction of the upper surface. Furthermore, an orthogonal projection of the masking portion on the substrate overlaps with an orthogonal projection of the metal pattern on the substrate.

In addition, the blocking wall includes an outer wall and an inner wall being in contact with the outer wall. The outer wall is a light absorbing structure, and the inner wall is a light reflecting structure.

In addition, the optoelectronic device further includes a second light-transmissive component disposed between the light emitting/receiving unit and the first light-transmissive component. The second light-transmissive component is covered on the active area and has a refractive index between a refractive index of the light emitting/receiving unit and a refractive index of the first light-transmissive component.

In conclusion, in the optoelectronic device provided by the present disclosure, by virtue of a mask covering the metal pattern and a light shielding layer disposed on the substrate and surrounding the light emitting/receiving unit, the metal pattern and other metal structures of the substrate can become invisible.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIGS. 1-2 are respectively schematic top and side views of an optoelectronic device according to a first embodiment of the present disclosure;

FIGS. 3-4 are respectively schematic top and side views of an optoelectronic device according to a second embodiment of the present disclosure, showing an implementation of a blocking wall;

FIGS. 5-6 are respectively schematic top and side views of the optoelectronic device according to the second embodiment of the present disclosure, showing another implementation of the blocking wall;

FIGS. 7-8 are respectively schematic top and side views of an optoelectronic device according to a third embodiment of the present disclosure;

FIGS. 9-10 are respectively schematic top and side views of an optoelectronic device according to a fourth embodiment of the present disclosure; and

FIGS. 11-12 are respectively schematic top and side views of an optoelectronic device according to a fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

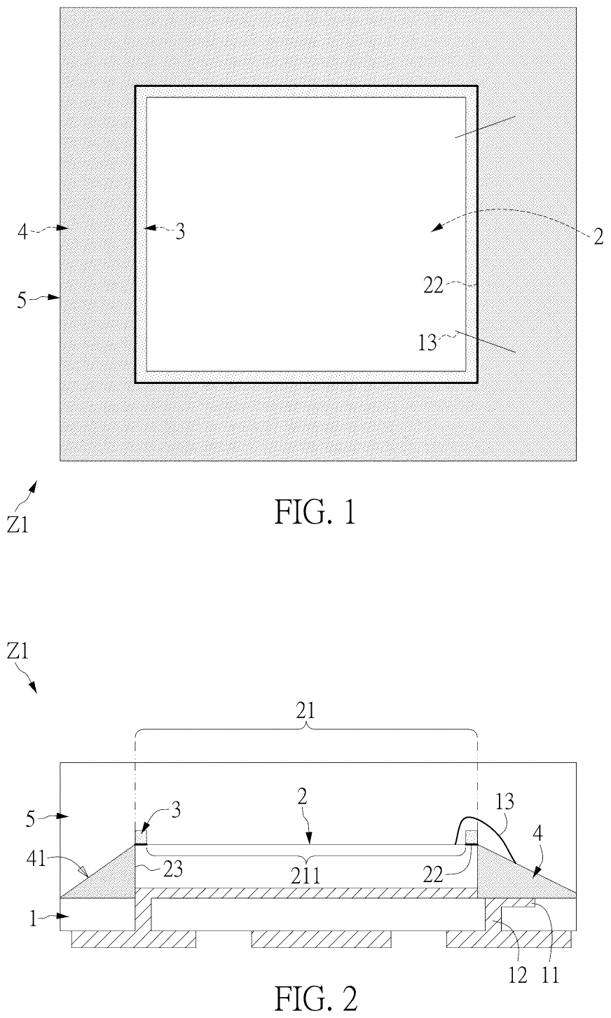

Referring to FIG. 1 and FIG. 2, a first embodiment of the present disclosure provides an optoelectronic device Z1, which can be applied to smart wearable products such as smart watches. The optoelectronic device Z1 includes a substrate 1, a light emitting/receiving unit 2, a mask 3, a light shielding layer 4, and a first light-transmissive component 5.

In the first embodiment, the light emitting/receiving unit 2 is disposed on the substrate 1, and includes an emitting/receiving side 21 and a metal pattern 22 disposed on the emitting/receiving side 21. The emitting/receiving side 21 has an active area 211, and the metal pattern 22 surrounds the active area 211. The mask 3 covers the metal pattern 22. For example, the metal pattern 22 includes a metal ring formed at the periphery of the emitting/receiving side 21 and at least one metal pad located outside of the metal ring, and the mask 3 is disposed over the metal ring and the at least one metal pad. The light shielding layer 4 is disposed on the substrate 1 and surrounds the light emitting/receiving unit 2. The first light-transmissive component 5 covers the light emitting/receiving unit 2, the mask 3, and the light shielding layer 4. Therefore, the optoelectronic device Z1 can meet the appearance requirements of smart wearable products, such as avoiding the exposing of metal surfaces. More technical details will be described in the following paragraphs.

The substrate 1 can be a circuit substrate with a plurality of metal pads 11 and a plurality of conductive structures 12 (e.g., conductive vias) for providing electrical conduction between the metal pads 11. The light emitting/receiving unit 2 can be an LED or a PD (photodiode) chip. The light emitting/receiving unit 2 can be mounted on one of the metal pads 11 and electrically connected to another one of the metal pads 11 via a wire 13. In practice, the light emitting/receiving unit 2 can work with a light emitting unit (not shown) to monitor physiological signals (e.g., blood oxygen concentrations and heart rates). For example, the light emitting unit is configured to emit light having a predetermined wavelength to an organism to be detected, and the light emitting/receiving unit 2 is configured to receive the light reflected by the organism.

The mask 3 has the same pattern (i.e., a ring pattern) as the metal pattern 22, and the metal pattern 22 is within the cover range of the mask 3. Furthermore, the mask 3 can be formed from a polymer material by dispensing, and can have a black or dark color to make the metal pattern 22 invisible. In practice, a cover rate of the emitting/receiving side 21 being covered with the mask 3 is not more than 10%, preferably ranges from 0.5% to 5%, and more preferably ranges from 1% to 3%. The thickness of the mask 3 is greater than 0.01 mm and less than 0.02 mm.

The light shielding layer 4 can abut against a plurality of side surfaces 23 of the light emitting/receiving unit 2. Therefore, the crosstalk of light to be received by the side surfaces 23 can be reduced. Furthermore, the light shielding layer 4 can be formed from a polymer material by dispensing, in which a thickness of the light shielding layer 4 is gradually decreased along a direction away from the light emitting/receiving unit 2, i.e., an upper surface 41 of the light shielding layer 4 is an inclined surface making an angle relative to the corresponding side surface 23. The light shielding layer 4 can have a black or dark color to have light absorption ability as well as to make the metal pads 11 invisible. In practice, the light shielding layer 4 has a transmittance of less than 0.5% with respect to light having a wavelength ranging from 100 nm to 2500 nm.

In one embodiment not shown in FIG. 1, the upper surface 41 of the light shielding layer 4 is a concave surface or a planar surface that is flush with an upper surface of the light emitting/receiving unit 2.

In practice, the mask 3 can be formed from the same material (i.e., a black or dark gray polymer material) as the light shielding layer 4. The mask 3 and the light shielding layer 4 can be formed in the same step or different steps.

The first light-transmissive component 5 is configured to allow light to pass therethrough so as to be received by the light emitting/receiving unit 2, and can protect the the light emitting/receiving unit 2 from physical damage and negative effects caused by surrounding environmental factors such as oxygen and moisture. Furthermore, the first light-transmissive component 5 can be formed from a transparent packaging material by molding. The transparent packaging material can be an epoxy resin system or a silicone system, but is not limited thereto.

### Second Embodiment

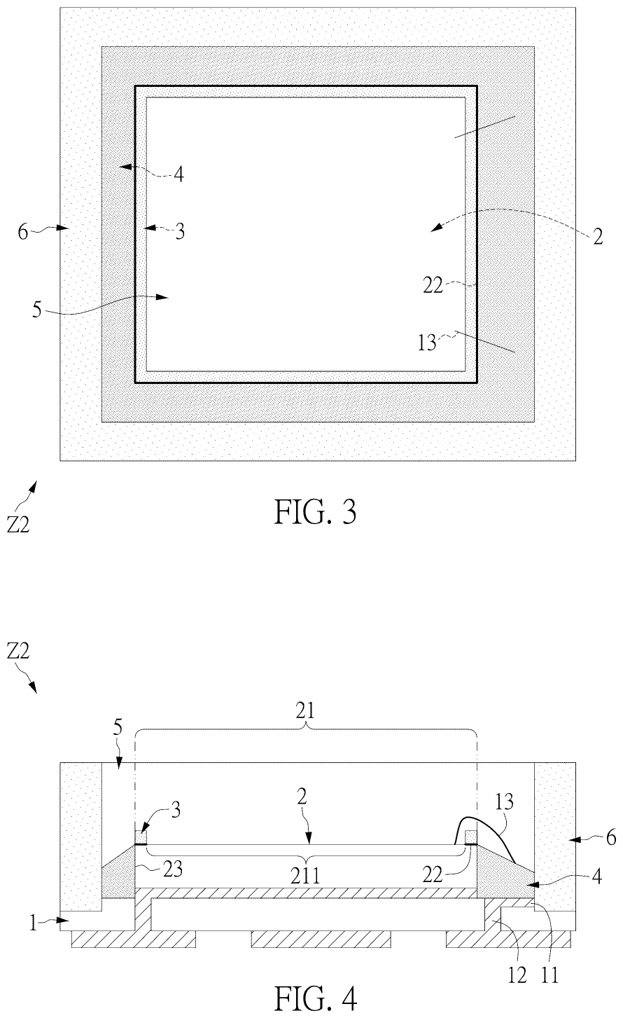

Referring to FIG. 3 and FIG. 4, a second embodiment of the present disclosure provides an optoelectronic device Z2, which includes a substrate 1, a light emitting/receiving unit 2, a mask 3, a light shielding layer 4, a first light-transmissive component 5, and a blocking wall 6. It is worth mentioning that the crosstalk in the optoelectronic device Z2 of the second embodiment can be effectively reduced compared to that in the optoelectronic device Z1 of the first embodiment. Furthermore, the light emitting/receiving unit 2 in the optoelectronic device Z2 of the second embodiment can have a narrower view angle so as to improve accuracy.

In the second embodiment, the light emitting/receiving unit 2 is disposed on the substrate 1, and includes an emitting/receiving side 21 and a metal pattern 22 disposed on the emitting/receiving side 21. The emitting/receiving side 21 has an active area 211, and the metal pattern 22 surrounds the active area 211. The mask 3 covers the metal pattern 22. The light shielding layer 4 is disposed on the substrate 1 and surrounds the light emitting/receiving unit 2. The first light-transmissive component 5 covers the light emitting/receiving unit 2, the mask 3, and the light shielding layer 4. The blocking wall 6 is disposed on the substrate 1 and surrounds the light emitting/receiving unit 2, the mask 3, the light shielding layer 4, and the first light-transmissive component 5. The technical details of the substrate 1, the light emitting/receiving unit 2, the mask 3, the light shielding layer 4, and the first light-transmissive component 5 have been described in the first embodiment, and will not be reiterated herein. In the present embodiment, a bottom of the blocking wall 6 extends into the substrate 1 so as to realize a better light blocking effect. In an embodiment that is not shown, the blocking wall 6 can be integrated on a surface of the substrate 1.

As shown in FIG. 3, the blocking wall 6 and the light emitting/receiving unit 2 have a gap therebetween that is filled with the light shielding layer 4. The blocking wall 6 can be formed from a polymer material by molding, and has a black or dark color to have light absorption ability. In practice, the blocking wall 6 can be formed from the same material (i.e., a black or dark gray polymer material, or silicone-based resin with black carbon) as the light shielding layer 4, so that it has a transmittance of less than 0.5% with respect to light having a wavelength ranging from 100 nm to 2500 nm.

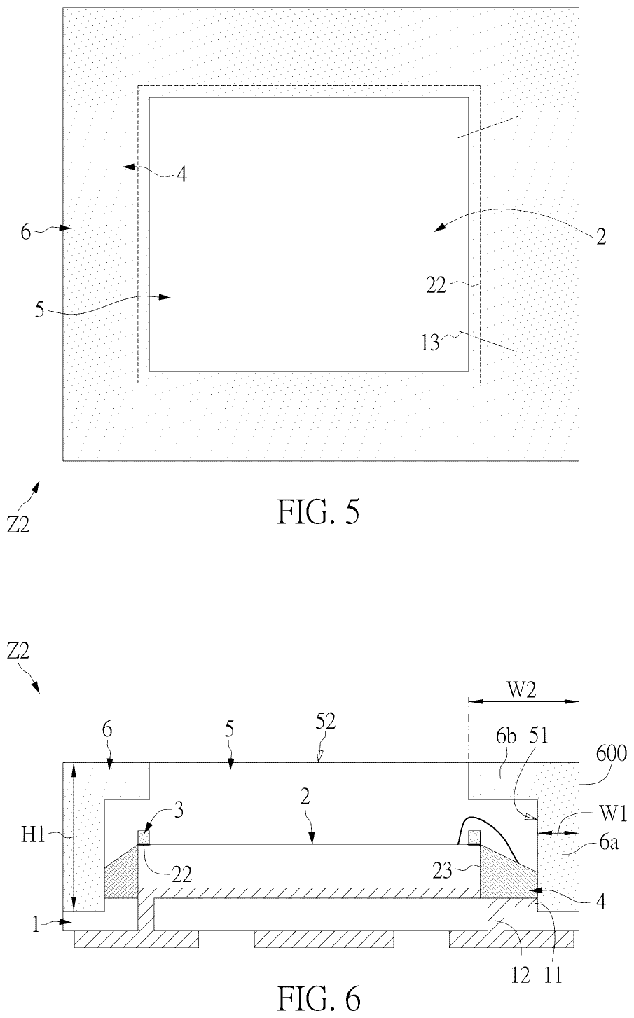

Reference is made to FIG. 5 and FIG. 6. In order to further narrow the view angle of the light emitting/receiving unit 2 as well as avoid the exposing of the metal pattern 22, the blocking wall 6 can include a shielding portion 6a and a masking portion 6b protruding inward form the shielding portion. The shielding portion 6a is formed as an annular wall, and the masking portion 6b is formed as a cover frame. The shielding portion 6a extends form the inward of the substrate 1 and in a direction parallel to an extension direction of a lateral surface 51 of the first light-transmissive component 5. The masking portion 6b extends in a direction parallel to an extension direction of an upper surface 52 of the first light-transmissive component 5, in which an orthogonal projection of the masking portion 6b on the substrate 1 overlaps with an orthogonal projection of the metal pattern 22 on the substrate 1.

More specifically, the blocking wall 6 and the first light-transmissive component 5 complement each other in shape. The shielding portion 6a surrounds the light emitting/receiving unit 2, the mask 3, and the light shielding layer 4, and can shield the light emitting/receiving unit 2 from stray light. The masking portion 6b covers the mask 3 and the light shielding layer 4, such that the metal pads 11 and the metal pattern 22 are completely within the cover range of the masking portion 6b, thereby avoiding the exposing of metal surfaces. In addition, the masking portion 6b can also be used to absorb stray light.

In one of the possible or preferred embodiments, a height H1 of the blocking wall 6 is approximately 0.45±0.05 mm, in which a width W1 of the shielding portion 6a is approximately 0.15±0.05 mm, and a width W2 of the masking portion 6b is approximately 0.5±0.05 mm.

### Third Embodiment

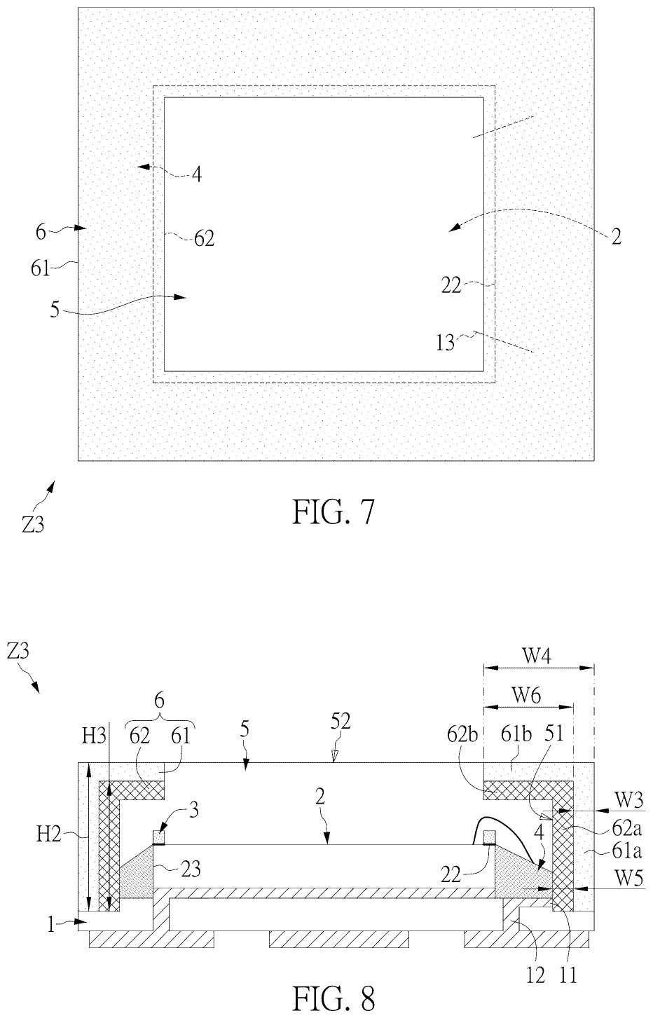

Referring to FIG. 7 and FIG. 8, a third embodiment of the present disclosure provides an optoelectronic device Z3, which includes a substrate 1, a light emitting/receiving unit 2, a mask 3, a light shielding layer 4, a first light-transmissive component 5, and a blocking wall 6. The main difference between the third embodiment and the second embodiment is as follows: in the third embodiment, the blocking wall 6 includes an outer wall 61 and an inner wall 62 being in contact with the outer wall 61, and the outer wall 61 is a light absorbing structure and the inner wall 62 is a light reflecting structure. Therefore, the optoelectronic device Z3 can have an increase in photo current.

In the third embodiment, each of the outer wall 61 and the inner wall 62 can be formed from a polymer material by molding, in which the outer wall 61 has a black or dark color to have light absorption ability, and the inner wall 62 has a white color to have light reflection ability. In practice, the outer wall 61 has a transmittance of less than 0.5% with respect to light having a wavelength ranging from 100 nm to 2500 nm. The inner wall 62 has a reflectance of greater than 96% with respect to light having a wavelength ranging from 100 nm to 1100 nm. However, the above description is disclosed for exemplary purposes only, and is not meant to limit the scope of the present disclosure. For example, the inner wall 62 can be a highly reflective metal structure.

Furthermore, the outer wall 61 and the inner wall 62 each include a shielding portion 61a, 62a and a masking portion 61b, 62b protruding inward form the shielding portion 61a, 62a. The shielding portions 61a, 62a extend form inward of the substrate 1 and in a direction parallel to an extension direction of a lateral surface 51 of the first light-transmissive component 5. The masking portions 61b, 62b extend in a direction parallel to an extension direction of an upper surface 52 of the first light-transmissive component 5, in which an orthogonal projection of each of the masking portions 61b, 62b on the substrate 1 overlaps with an orthogonal projection of the metal pattern 22 on the substrate 1.

More specifically, the blocking wall 6 and the first light-transmissive component 5 complement each other in shape. The shielding portions 61a, 62a surround the light emitting/receiving unit 2, the mask 3, and the light shielding layer 4, in which the shielding portion 61a can shield the light emitting/receiving unit 2 from stray light, and the shielding portion 62a can prevent incident light from being absorbed by the shielding portion 61a. The masking portions 61b, 62b cover the mask 3 and the light shielding layer 4, such that the metal pads 11 and the metal pattern 22 are completely within the cover range of each of the masking portions 61b, 62b, thereby avoiding the exposing of metal surfaces. In addition, the masking portion 61b can be used to absorb stray light, and the masking portion 62b can prevent incident light from being absorbed by the masking portion 61b.

In one of the possible or preferred embodiments, a height H2 of the outer wall 61 is approximately 0.45±0.05 mm, in which a width W3 of the shielding portion 61a is approximately 0.075±0.01 mm, and a width W4 of the masking portion 61b is approximately 0.5±0.05 mm. A height H3 of the inner wall 62 is approximately 0.35±0.05 mm, in which a width W5 of the shielding portion 62a is approximately 0.075±0.01 mm, and a width W6 of the masking portion 62b is approximately 0.4±0.05 mm.

### Fourth Embodiment

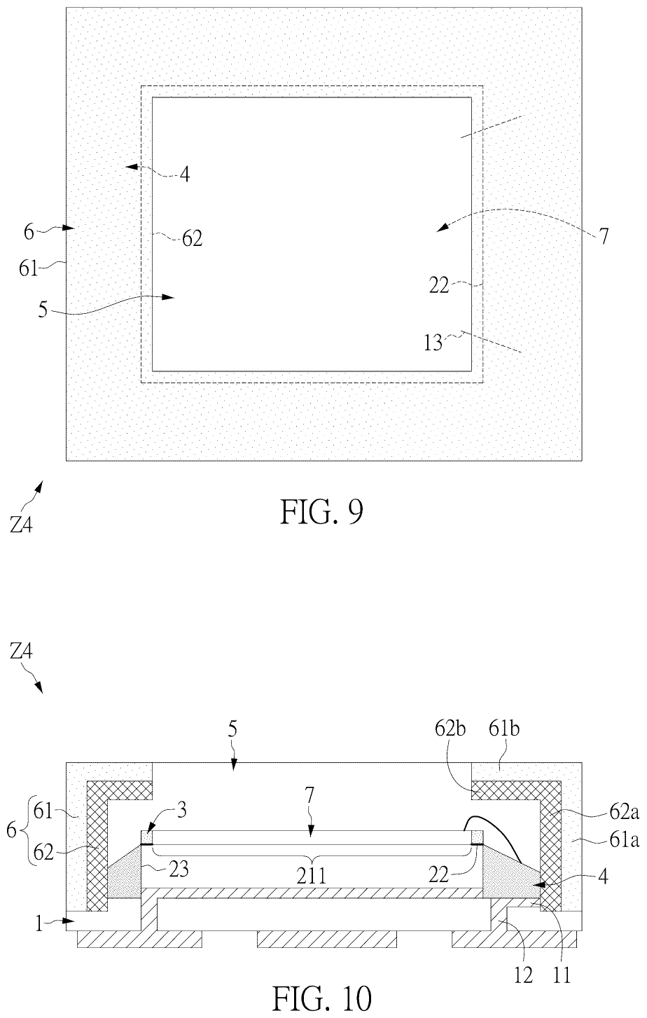

Referring to FIG. 9 and FIG. 10, a fourth embodiment of the present disclosure provides an optoelectronic device Z4, which includes a substrate 1, a light emitting/receiving unit 2, a mask 3, a light shielding layer 4, a first light-transmissive component 5, a blocking wall 6, and a second light-transmissive component 7. The main difference between the fourth embodiment and the third embodiment is as follows: in the fourth embodiment, the second light-transmissive component 7 is disposed between the light emitting/receiving unit 2 and the first light-transmissive component 5, and has a refractive index between a refractive index of the light emitting/receiving unit 2 and a refractive index of the first light-transmissive component 5. Therefore, the optoelectronic device Z4 can have a greater increase in photo current than the increase in photo current of the optoelectronic device Z3 of the third embodiment.

In the fourth embodiment, the second light-transmissive component 7 is covered on the active area 211 to provide refractive index matching between the light emitting/receiving unit 2 and the first light-transmissive component 5. Furthermore, the mask 3 surrounds and is in contact with the second light-transmissive component 7. In practice, the second light-transmissive component 7 can be formed from a silicone-based resin. The refractive index of the second light-transmissive component 7 is between 1.51 and 1.55, and the refractive index of the first light-transmissive component 5 is between 1.4 and 1.5.

### Fifth Embodiment

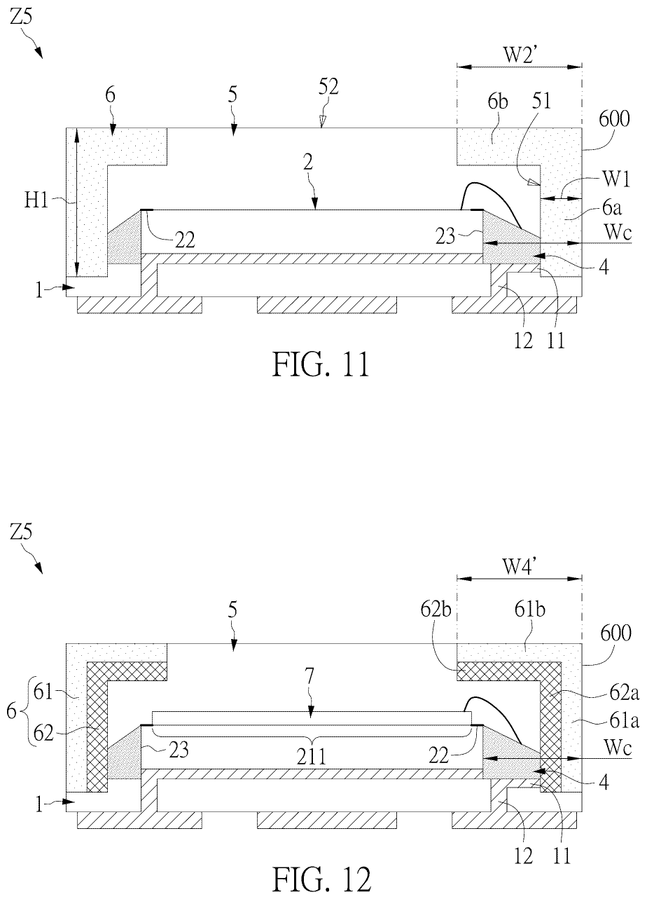

Referring to FIG. 11, a fifth embodiment of the present disclosure provides an optoelectronic device Z5, which mainly includes a substrate 1, a light emitting/receiving unit 2, a light shielding layer 4, a first light-transmissive component 5, and a blocking wall 6. The main difference between the fifth embodiment and the second embodiment is as follows: in the fifth embodiment, a metal pattern 22 of the light emitting/receiving unit 2 is completely within the cover range of a masking portion 6b of the blocking wall 6 so as to become invisible, such that a mask used to cover the metal pattern 22 can be omitted. More specifically, a width W2′ of the masking portion 6b is approximately greater than 1.02 times and less than 1.06 times a distance Wc between a side surface 23 of the light emitting/receiving unit 2 and an outer side surface 600 of the blocking wall 6. In the other word, the width W2′ is designed to be greater than the sum of the distance Wc and the width of the metal pattern, thus the metal pattern 22 of the light emitting/receiving unit can be shielded completely. Moreover, the width W2′ is designed to be less than 1.02, it ensures that the light emitting/receiving unit 2 maintains a sufficient area for light emission and reception, thereby preserving its accuracy.

Reference is made to FIG. 12, the blocking wall 6 can include an outer wall 61 and an inner wall 62 being in contact with the outer wall 61, and the outer wall 61 is a light absorbing structure and the inner wall 62 is a light reflecting structure. The outer wall 61 and an inner wall 62 each include a shielding portion 61a, 62a and a masking portion 61b, 62b protruding inward form the shielding portion 61a, 62a. Similarly, a width W4′ of the masking portion 61b is approximately greater than 1.02 times and less than 1.06 times the distance Wc. Similarly, the width W4′ is greater than a sum of the distance Wc and the width of the metal pattern and less than 1.02. In addition, the optoelectronic device Z5 can further include a second light-transmissive component 7 that is formed over an active area 211 of the light emitting/receiving unit 2 to provide refractive index matching between the light emitting/receiving unit 2 and the first light-transmissive component 5.

The relevant technical details mentioned in the above embodiments are still valid in the fifth embodiment and will not be repeated herein for the sake of brevity.

### Beneficial Effects of the Embodiments

In conclusion, in the optoelectronic device provided by the present disclosure, by virtue of a mask covering the metal pattern and a light shielding layer disposed on the substrate and surrounding the light emitting/receiving unit, the metal pattern and other metal structures of the substrate can become invisible.

Furthermore, the optoelectronic device can further include a blocking wall that at least surrounds the light emitting/receiving unit. Therefore, the crosstalk of external light signals can be effectively reduced, and the light emitting/receiving unit can have a narrower view angle so as to improve accuracy. Moreover, the blocking wall can include an outer wall being a light absorbing structure and an inner wall being a light reflecting structure. Therefore, the optoelectronic device can have an increase in photo current.

In addition, the optoelectronic device can further include a second light-transmissive component that is disposed between the light emitting/receiving unit and the first light-transmissive component, thereby increasing the increment of photo current.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optoelectronic device, comprising:
a substrate;
a light emitting/receiving unit disposed on the substrate and including an emitting/receiving side and a metal pattern disposed on the emitting/receiving side, wherein the emitting/receiving side has an active area, and the metal pattern surrounds the active area;
a mask covering the metal pattern;
a light shielding layer disposed on the substrate and surrounding the light emitting/receiving unit; and
a first light-transmissive component covering the light emitting/receiving unit, the mask, and the light shielding layer.

2. The optoelectronic device according to claim 1, wherein a thickness of the light shielding layer is gradually decreased along a direction away from the light emitting/receiving unit.

3. The optoelectronic device according to claim 1, wherein the light shielding layer has a transmittance of less than 0.5% with respect to light having a wavelength ranging from 100 nm to 2500 nm.

4. The optoelectronic device according to claim 1, wherein a cover rate of the emitting/receiving side being covered with the mask is not more than 10%.

5. The optoelectronic device according to claim 1, further comprising a blocking wall that is disposed on the substrate and surrounds the light emitting/receiving unit, the mask, the light shielding layer, and the first light-transmissive component.

6. The optoelectronic device according to claim 5, wherein the blocking wall includes an outer wall and an inner wall being in contact with the outer wall, the outer wall is a light absorbing structure, and the inner wall is a light reflecting structure.

7. The optoelectronic device according to claim 5, wherein the blocking wall has a transmittance of less than 0.5% with respect to light having a wavelength ranging from 100 nm to 2500 nm.

8. The optoelectronic device according to claim 5, wherein the blocking wall includes a shielding portion and a masking portion protruding inward form the shielding portion, and an orthogonal projection of the masking portion on the substrate overlaps with an orthogonal projection of the metal pattern on the substrate.

9. The optoelectronic device according to claim 8, wherein the blocking wall includes an outer wall and an inner wall being in contact with the outer wall, the outer wall is a light absorbing structure, and the inner wall is a light reflecting structure.

10. The optoelectronic device according to claim 6, wherein the outer wall has a transmittance of less than 0.5% with respect to light having a wavelength ranging from 100 nm to 2500 nm, and the inner wall has a reflectance of greater than 96% with respect to light having a wavelength ranging from 100 nm to 1100 nm.

11. The optoelectronic device according to claim 1, further comprising a second light-transmissive component disposed between the light emitting/receiving unit and the first light-transmissive component, wherein the second light-transmissive component is covered on the active area and has a refractive index between a refractive index of the light emitting/receiving unit and a refractive index of the first light-transmissive component.

12. The optoelectronic device according to claim 10, wherein the refractive index of the second light-transmissive component is between 1.51 and 1.55, and the refractive index of the first light-transmissive component is between 1.4 and 1.5.

13. An optoelectronic device, comprising:
a substrate;
a light emitting/receiving unit disposed on the substrate and including an emitting/receiving side and a metal pattern disposed on the emitting/receiving side, wherein the emitting/receiving side has an active area, and the metal pattern surrounds the active area;
a light shielding layer disposed on the substrate and surrounding the light emitting/receiving unit;
a first light-transmissive component covering the light emitting/receiving unit, the mask, and the light shielding layer;
a second light-transmissive component disposed between the light emitting/receiving unit and the first light-transmissive component, wherein the second light-transmissive component is covered on the active area and has a refractive index between a refractive index of the light emitting/receiving unit and a refractive index of the first light-transmissive component; and
a blocking wall disposed on the substrate and surrounding the light emitting/receiving unit, the light shielding layer, the first light-transmissive component, and the second light-transmissive component; wherein the blocking wall includes an outer wall and an inner wall being in contact with the outer wall, the outer wall is a light absorbing structure, and the inner wall is a light reflecting structure.

14. The optoelectronic device according to claim 13, wherein a thickness of the light shielding layer is gradually decreased along a direction away from the light emitting/receiving unit.

15. The optoelectronic device according to claim 13, wherein the light shielding layer has a light transmittance of less than 0.5% with respect to light having a wavelength ranging from 100 nm to 2500 nm, the outer wall has a transmittance of less than 0.5% with respect to light having a wavelength ranging from 100 nm to 2500 nm, and the inner wall has a reflectance of greater than 96% with respect to light having a wavelength ranging from 100 nm to 1100 nm.

16. The optoelectronic device according to claim 13, further comprising a mask covering the metal pattern, wherein a cover rate of the emitting/receiving side being covered with the mask is not more than 10%.

17. The optoelectronic device according to claim 13, wherein the outer wall and the inner wall each include a shielding portion and a masking portion protruding inward form the shielding portion, and an orthogonal projection of the masking portion on the substrate overlaps with an orthogonal projection of the metal pattern on the substrate.

18. The optoelectronic device according to claim 13 wherein the refractive index of the second light-transmissive component is between 1.51 and 1.55, and the refractive index of the first light-transmissive component is between 1.4 and 1.5.

19. An optoelectronic device, comprising:
a substrate;
a light emitting/receiving unit disposed on the substrate and including an emitting/receiving side and a metal pattern disposed on the emitting/receiving side, wherein the emitting/receiving side has an active area, and the metal pattern surrounds the active area;
a light shielding layer disposed on the substrate and surrounding the light emitting/receiving unit;
a first light-transmissive component covering the light emitting/receiving unit, the mask, and the light shielding layer; and
a blocking wall disposed on the substrate and surrounding the light emitting/receiving unit, the light shielding layer, and the first light-transmissive component; wherein the blocking wall includes an outer wall and an inner wall being in contact with the outer wall, the outer wall and the inner wall each include a shielding portion and a masking portion protruding inward form the shielding portion, and an orthogonal projection of the masking portion on the substrate overlaps with an orthogonal projection of the metal pattern on the substrate.

20. The optoelectronic device according to claim 19, wherein a width of the masking portion is approximately greater than 1.02 times and less than 1.06 times a distance between a side surface of the light emitting/receiving unit and an outer side surface of the blocking wall.
